(19) United States
(12) Patent Application Publication
(10) Pub. No.: US 2026/0367048 A1
(43) Pub. Date: Nov. 19, 2026

(54) GAS CHROMATOGRAPH APPARATUS, MEASURING TUBE UNIT, AND METHOD FOR MANUFACTURING MEASURING TUBE UNIT

(71) Applicant: SHIMADZU CORPORATION, Kyoto-shi (JP)

(72) Inventor: Ryosuke YAMAMOTO, Kyoto-shi (JP)

(21) Appl. No.: 19/404,220

(22) Filed: Dec. 1, 2025

(30) Foreign Application Priority Data
Dec. 10, 2024 (JP) 2024-215108

(51) Int. Cl. G01N 30/30; G01N 30/02

(52) U.S. Cl. CPC G01N 30/30; G01N 2030/025; G01N 2030/3084

(57) ABSTRACT

A gas chromatograph apparatus analyzes components contained in a gas to be analyzed. The gas chromatograph apparatus includes a measuring tube and a heater block. The measuring tube measures the gas. The heater block heats the measuring tube to a predetermined temperature. The measuring tube is in contact with the heater block and is wound around the heater block.

### TECHNICAL FIELD

The present disclosure relates to a gas chromatograph apparatus and a measuring tube unit, as well as a method for manufacturing a measuring tube unit, and more specifically, to a technology for improving the measurement accuracy of a sample gas in a measuring tube.

### BACKGROUND ART

In a gas chromatograph apparatus, a sample gas to be analyzed is adjusted to a quantity suitable for analysis by a measuring tube sample loop heated by a heater block, and is then analyzed.

For example, Japanese Unexamined Patent Application Publication No. H8-304368 (Patent Literature 1) discloses a gas chromatograph in which a sample gas is introduced into an analysis unit via a sample loop.

### CITATION LIST

### PATENT LITERATURE

Patent Literature 1 Japanese Unexamined Patent Application Publication No. H8- 304368

### SUMMARY OF INVENTION

### TECHNICAL PROBLEM

The sample loop for adjusting the sample gas to a quantity suitable for analysis is generally disposed in a hollow space within a box where a heater block is located, and is not in direct contact with the heater block. Therefore, in a conventional gas chromatograph apparatus, the sample loop is indirectly heated by the air within the box warmed by the heater block, which could result in a difference between the actual temperature of the sample gas in the sample loop and the set temperature of the heater block that heats the sample loop. Since the volume of the sample gas in the sample loop changes with temperature, if the temperature of the sample loop differs from the temperature of the temperature-controlled heater block, the measurement accuracy of the sample gas in the sample loop could be degraded in some cases.

The present disclosure has been made to solve the problems described above, and an object thereof is to improve the measurement accuracy of a sample gas in a sample loop in a gas chromatograph apparatus.

### SOLUTION TO PROBLEM

A gas chromatograph apparatus according to an aspect of the present disclosure analyzes components contained in a gas to be analyzed. The gas chromatograph apparatus includes

a measuring tube and a heater block. The measuring tube measures the gas. The heater block heats the measuring tube to a predetermined temperature. The measuring tube is in contact with the heater block and is wound around the heater block.

A measuring tube unit according to another aspect of the present disclosure is used in a gas chromatograph apparatus that analyzes components contained in a gas to be analyzed. The measuring tube unit includes a measuring tube and a heater block. The measuring tube measures the gas. The heater block heats the measuring tube to a predetermined temperature. The measuring tube is in proximity to the heater block and is wound around the heater block.

A manufacturing method according to yet another aspect of the present disclosure relates to a method for manufacturing a measuring tube unit used in a gas chromatograph apparatus that analyzes components contained in a gas to be analyzed. The measuring tube unit includes a measuring tube and a heater block. The measuring tube measures the gas. The heater block heats the measuring tube to a predetermined temperature. The heater block includes a cylindrical cylinder portion. The manufacturing method includes a step of preparing the heater block, a step of forming the measuring tube into a helical shape with an inner diameter smaller than an outer diameter of the cylinder portion, and a step of winding the formed measuring tube around the cylinder portion in close contact while expanding it.

### ADVANTAGEOUS EFFECTS OF INVENTION

In the gas chromatograph apparatus of the present disclosure, by winding the sample loop around the heater block, the sample loop can be heated in a position proximate to the heater block. Therefore, the difference between the actual temperature of the sample gas in the sample loop and the set temperature of the heater block that heats the sample loop can be reduced, and thus the measurement accuracy of the sample gas in the sample loop can be improved.

### BRIEF DESCRIPTION OF DRAWINGS

FIG. 1 is a diagram illustrating an example of the overall configuration of a gas chromatograph apparatus according to an embodiment.

FIG. 2 is a diagram showing the configuration of a control device in the gas chromatograph apparatus.

FIG. 3 is an external view of a sample loop unit in a comparative example.

FIG. 4 is a detailed external view of a sample loop unit according to the embodiment.

FIG. 5 is an external view of a sample loop unit in a modified example.

FIG. 6 is a graph showing temperature changes of a sample loop and a heater in the embodiment.

FIG. 7 is a flowchart showing a manufacturing procedure for the sample loop unit of the gas chromatograph apparatus according to the embodiment.

### DESCRIPTION OF EMBODIMENTS

Hereinafter, embodiments of the present disclosure will be described in detail with reference to the drawings. Note that identical or corresponding parts in the drawings are denoted by the same reference signs, and a description thereof will not be repeated.

### Configuration of Gas Chromatograph Apparatus 100

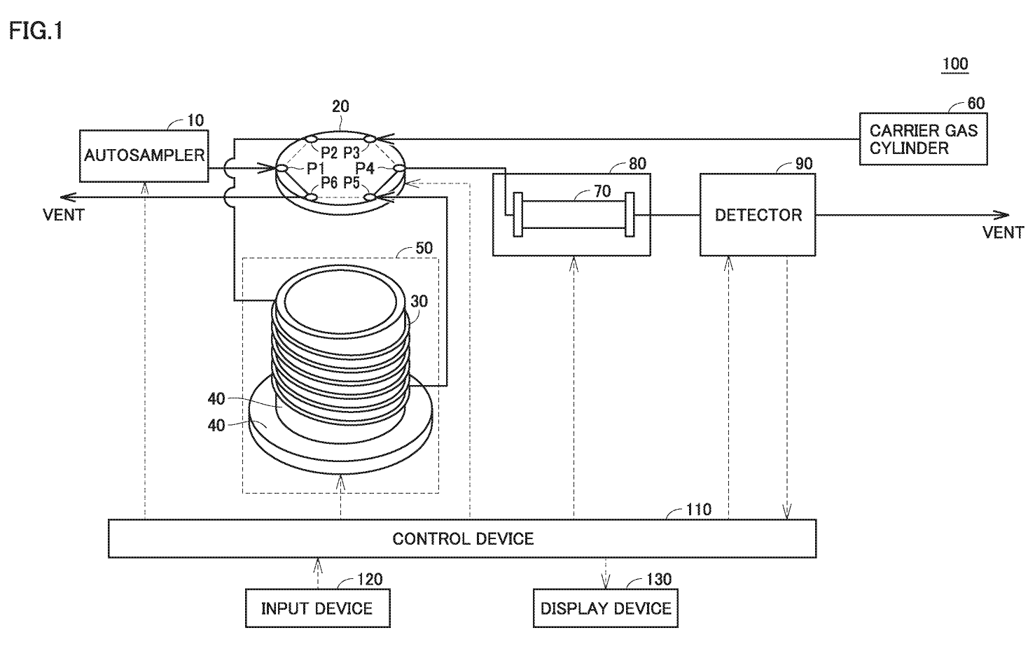

FIG. 1 is a diagram illustrating an example of the overall configuration of a gas chromatograph apparatus 100 according to an embodiment. The gas chromatograph apparatus 100 is an apparatus that separates components contained in a sample gas to be analyzed for each component and analyzes them.

The gas chromatograph apparatus 100 includes an autosampler 10, a flow path switching device 20, a sample loop unit 50, a carrier gas cylinder 60, a column 70, a column oven 80, a detector 90, a control device 110, an input device 120, and a display device 130. The devices constituting the gas chromatograph apparatus 100 are connected by piping. This piping constitutes a flow path.

The autosampler 10 is controlled by the control device 110 and supplies a sample gas of a desired type and quantity. The autosampler 10 may be disposed in the same housing as other components of the gas chromatograph apparatus 100, or may be disposed outside the housing.

The sample loop unit 50 adjusts the sample gas supplied from the autosampler 10 to a quantity suitable for analysis. The sample loop unit 50 includes a sample loop 30 and a heater block 40.

The sample loop 30 is a pipe through which the sample gas flows, and it adjusts the quantity of the sample gas therein. The quantity of gas introduced into the sample loop 30 differs depending on the length and inner diameter of the sample loop 30. Therefore, a user, a field engineer, or the like can change the quantity of the sample gas to be analyzed to a desired quantity by changing the sample loop 30.

The heater block 40 is controlled by the control device 110 and heats the sample loop 30 to a predetermined temperature. The predetermined temperature is, for example, a temperature suitable for analysis or a temperature desired by the user. Since the volume of the sample gas changes with temperature, the sample gas can be appropriately measured by controlling the sample gas to a desired temperature with the heater block 40. This also allows for accurate analysis results to be obtained.

The carrier gas cylinder 60 is a cylinder that stores carrier gas. The carrier gas is, for example, a gas that does not interfere with the analysis results of the sample gas, such as helium or nitrogen, and is used to transport the sample gas to the detector 90 via the column 70. The carrier gas cylinder 60 is connected to the flow path switching device 20. By switching the flow path switching device 20, the sample gas measured by the sample loop 30 is transported to the column 70 using the carrier gas. The carrier gas cylinder 60 may be disposed in the same housing as other components of the gas chromatograph apparatus 100, or may be disposed independently outside the housing.

A mixed gas of the sample gas and the carrier gas supplied from the sample loop 30 flows inside the column 70, which separates the components contained in the sample gas for

each component. That is, the column 70 separates the sample gas for each component. Since the time taken to pass through the column 70 differs depending on the component, the sample gas can be separated for each component.

The column oven 80 is controlled by the control device 110 and adjusts the temperature of the column 70 disposed therein to a temperature suitable for analysis. The column oven 80 has a temperature sensor (not shown) inside. With this temperature sensor, the temperature in the vicinity of the column 70 can be measured. By doing so, the control device 110 can perform feedback control to control the sample gas inside the column 70 to a desired temperature.

The detector 90 is controlled by the control device 110 and sequentially detects the various components separated by the column 70. The detector 90 is, for example, a thermal conductivity detector (TCD) or a flame ionization detector (FID). The mixed gas of the sample gas and the carrier gas discharged from the detector 90 is discharged to the outside of the gas chromatograph apparatus 100.

The flow path switching device 20 is configured, for example, by a six-port valve, has six ports P1 to P6, and switches between two flow path patterns in the gas chromatograph apparatus 100. The flow path switching device 20 is connected to the sample loop 30 and the column 70, and switches between supplying and stopping the supply of the sample gas measured in the sample loop 30 to the column 70. The flow path switching device 20 may be a four-port valve or a combination of other types of valves.

Port P1 of the flow path switching device 20 is connected to the outlet of the autosampler 10. Port P2 is connected to one end of the sample loop 30. Port P3 is connected to the outlet of the carrier gas cylinder 60. Port P4 is connected to the column 70. Port P5 is connected to the other end of the sample loop 30. Port P6 is connected to an outlet leading to the outside of the gas chromatograph apparatus 100.

The control device 110 controls the autosampler 10, the flow path switching device 20, the heater block 40, the column oven 80, the detector 90, and the display device 130. The control device 110 may be disposed in the same housing as other components of the gas chromatograph apparatus 100, or may be disposed outside the housing.

The input device 120 receives operation input from a user and transmits operation signals to the control device 110. The input device 120 is, for example, a keyboard, a touch panel, or a mouse. The input device 120 may be disposed in the same housing as other components of the gas chromatograph apparatus 100, or may be disposed outside the housing.

The display device 130 receives analysis results of the sample gas and the like from the control device 110 and displays them. The display device 130 is, for example, a display or a printer. The display device 130 may be disposed in the same housing as other components of the gas chromatograph apparatus 100, or may be disposed outside the housing.

### Flow Path Switching by Flow Path Switching Device 20

The flow path switching device 20 switches between a first flow path pattern and a second flow path pattern. The gas chromatograph apparatus 100 first prepares to analyze the components contained in the sample gas in the first flow path pattern. Then, the gas chromatograph apparatus 100 analyzes the components contained in the sample gas in the second flow path pattern.

In the first flow path pattern, as indicated by the broken lines in the flow path switching device 20 in FIG. 1, port P1 and port P2 of the flow path switching device 20 are connected, port P3 and port P4 are connected, and port P5 and port P6 are connected. Therefore, the sample gas supplied from the autosampler 10 flows in the order of port P1, port P2, the sample loop 30, port P5, and port P6, and is discharged to the outside of the gas chromatograph apparatus 100.

Thereafter, the control device 110 stops the supply of the sample gas from the autosampler 10 to the sample loop 30, and closes a valve (not shown) provided between the sample loop 30 and port P5 of the flow path switching device 20. By doing so, impurities can be discharged from the sample loop 30 to the outside, and the inside of the sample loop 30 can be filled with the sample gas. The sample gas is adjusted to a quantity suitable for analysis within the sample loop 30.

On the other hand, at this time, the carrier gas supplied from the carrier gas cylinder 60 flows in the order of port P3, port P4, the column 70, and the detector 90, and is discharged to the outside of the gas chromatograph apparatus 100. By doing so, impurities can be discharged from the column 70 and the detector 90 to the outside, and the inside of the column 70 and the detector 90 can be filled with the carrier gas.

In the second flow path pattern, as indicated by the solid lines in the flow path switching device 20 in FIG. 1, port P2 and port P3 of the flow path switching device 20 are connected, port P4 and port P5 are connected, and port P6 and port P1 are connected. Therefore, the autosampler 10 is in communication with port P1 and port P6. Thus, even if a sample gas is supplied from the autosampler 10, it is discharged to the outside of the gas chromatograph apparatus 100.

When the valve (not shown) provided between the sample loop 30 and port P5 of the flow path switching device 20 is opened, the carrier gas supplied from the carrier gas cylinder 60 flows in the order of port P3, port P2, the sample loop 30, port P5, port P4, the column 70, and the detector 90. That is, the carrier gas pushes out the sample gas measured in the sample loop 30 to introduce it into the column 70, and transports each component of the sample gas that has passed through the column 70 to the detector 90. In this way, the gas chromatograph apparatus 100 can analyze the components in the sample gas.

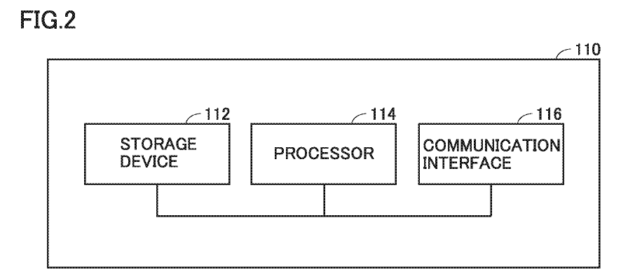

FIG. 2 is a diagram showing the configuration of the control device 110 in the gas chromatograph apparatus 100. As shown in FIG. 2, the control device 110 includes a storage device 112, a processor 114, and a communication interface 116, which are connected to each other via a common communication bus.

The communication interface 116 receives set values of various parameters of the gas chromatograph apparatus 100 and analysis results of the components of the sample gas from the input device 120 and the detector 90. The communication interface 116 also transmits signals to the autosampler 10, the flow path switching device 20, the heater block 40, the column oven 80, the detector 90, and the display device 130.

The storage device 112 stores various programs and data. The storage device 112 includes, for example, memory devices such as a ROM (Read Only Memory) and a RAM (Random Access Memory), and mass storage devices such as an HDD (Hard Disk Drive) and an SSD (Solid State Drive).

The processor 114 controls the autosampler 10, the flow path switching device 20, the heater block 40, the column oven 80, the detector 90, and the display device 130 of the gas chromatograph apparatus 100 based on various data stored in the storage device 112 and various data acquired from the communication interface 116. The processor 114 is, for example, an arithmetic processing unit such as a CPU (Central Processing Unit) or an MPU (Micro Processing Unit).

Note that the "sample loop" in the embodiment corresponds to the "measuring tube" in the present disclosure. Also, the "sample loop unit" in the embodiment corresponds to the "measuring tube unit" in the present disclosure.

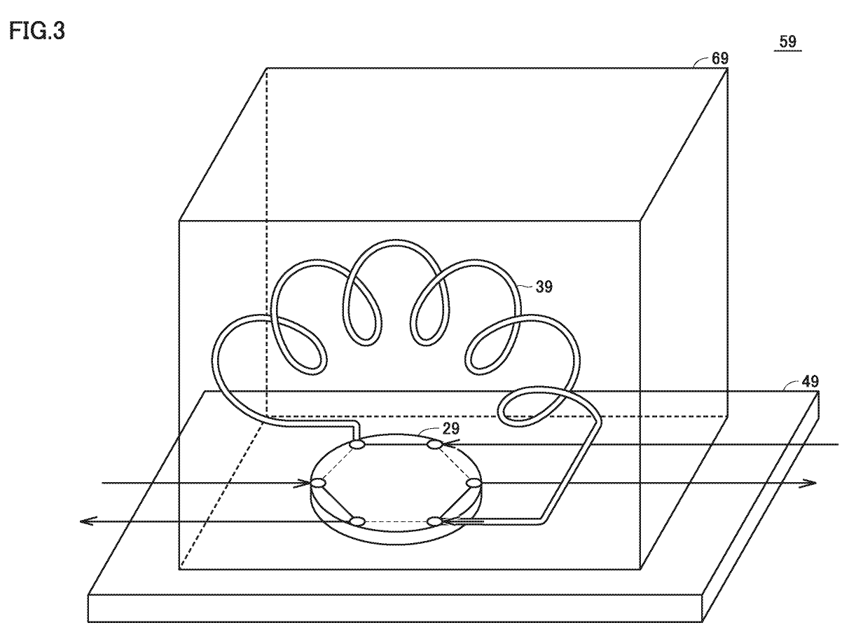

FIG. 3 is an external view of a sample loop unit 59 in a comparative example. A general sample loop unit 59 includes a flow path switching device 29, a sample loop 39, a heater block 49, and a box 69. A plane of the flow path switching device 29 is in contact with a plane of the heater block 49. The sample loop 39 is in contact with the flow path switching device 29.

However, as shown in FIG. 3, the sample loop 39 for adjusting the sample gas to a quantity suitable for analysis is generally disposed in a hollow space within the box 69 where the heater block 49 is located, and is not in direct contact with the heater block 49. Therefore, in the gas chromatograph apparatus of the comparative example, the sample loop 39 is indirectly heated by the air within the box 69 warmed by the heater block 49. As a result, a difference may occur between the actual temperature of the sample gas in the sample loop 39 and the set temperature of the heater block 49 that heats the sample loop 39. In addition, variations may occur in the actual temperature of the sample gas among different parts within the sample loop 39. Since the volume of the sample gas changes with temperature, the measurement accuracy of the sample gas by the sample loop 39 may be degraded in the gas chromatograph apparatus of the comparative example.

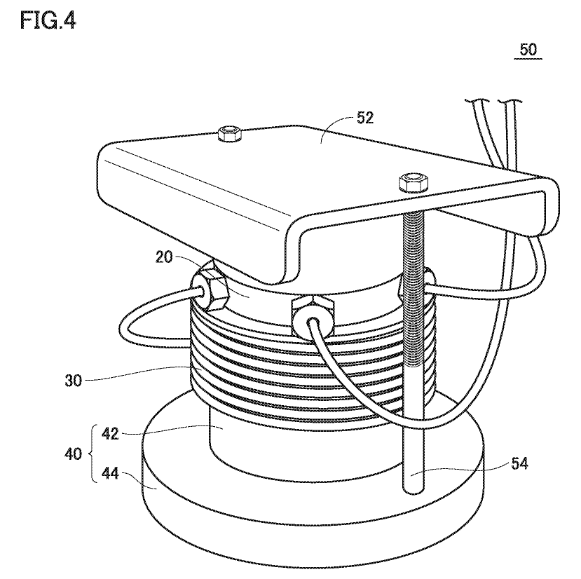

Therefore, in the sample loop unit 50 of the embodiment, the sample loop 30 is directly wound around the heater block 40, as shown in FIG. 1. FIG. 4 is a detailed external view of the sample loop unit 50 according to the embodiment. As shown in FIG. 4, the sample loop unit 50 according to the embodiment further includes a flow path switching device 20, a support member 52, and a fixing member 54, in addition to the sample loop 30 and the heater block 40.

The heater block 40 has a cylinder portion 42 and a flange portion 44. The cylinder portion 42 is a cylindrical metal member with a heater disposed inside. The cylinder portion 42 is not limited to a circular cylindrical shape, and may have a cylindrical shape with a

polygonal or elliptical cross-section. The flange portion 44 is disposed at one end of the cylinder portion 42 and protrudes outward from the outer periphery of the cylinder portion 42. The cylinder portion 42 is formed with a plurality of through holes for fixing the heater block 40. The sample loop 30 is in contact with the heater block 40 and is wound in a helical shape around the cylinder portion 42 of the heater block 40.

As shown in FIG. 4, the flow path switching device 20 is disposed so as to be in contact with an end of the cylinder portion 42 of the heater block 40 in the extending direction. Then, the heater block 40 and the flow path switching device 20 are fixed in close contact with each other by a plate-shaped support member 52 and a fixing member 54. More specifically, the flow path switching device 20 is disposed between the support member 52 and the heater block 40, and these devices are fixed by the fixing member 54 that passes through the support member 52 and the flange portion 44.

In this way, by directly winding the sample loop 30 around the cylinder portion 42 of the temperature-controlled heater block 40, the sample loop 30 can be heated in a position proximate to the heater block 40. Therefore, the difference between the actual temperature of the sample gas in the sample loop and the set temperature of the heater block that heats the sample loop can be reduced. In addition, variations in the actual temperature of the sample gas among different parts within the sample loop can be reduced. Therefore, the measurement accuracy of the sample gas in the sample loop can be improved.

Note that in FIG. 4, the configuration was such that the sample loop 30 was directly wound around the heater block 40. However, as in the modified example shown in FIG.

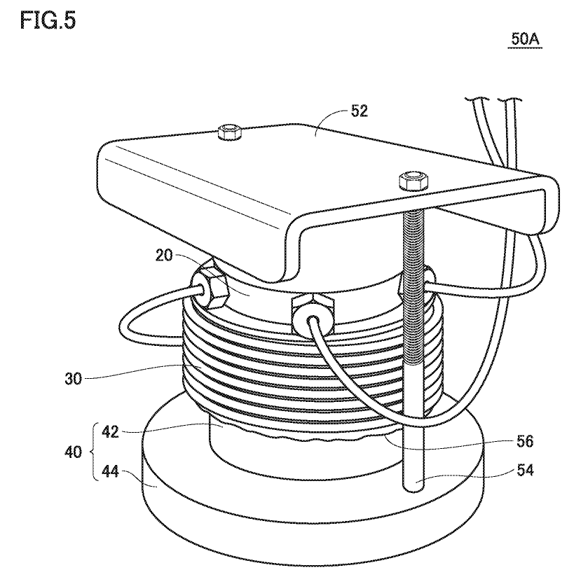

5, a highly thermally conductive member 56 may be disposed between the sample loop 30 and the heater block 40 so as to be in contact with the sample loop 30 and the heater block 40. FIG. 5 is an external view of a sample loop unit 50A in a modified example.

As shown in FIG. 5, in the sample loop unit 50A of the modified example, a thermally conductive member 56 is disposed so as to fill the gap between the sample loop 30 and the cylinder portion 42 of the heater block 40. The thermally conductive member 56 is, for example, a highly thermally conductive member such as a graphite sheet or an aluminum sheet. Therefore, by disposing the thermally conductive member 56, heat from the heater block 40 can be efficiently transferred to the sample loop 30 via the thermally conductive member 56. Therefore, the time required to reach a desired temperature can be shortened, and the power consumption of the heater can be suppressed.

In this way, by winding the sample loop 30 around the cylinder portion 42 in which the heater is incorporated in the heater block 40, the sample loop 30 can be heated in a position proximate to the heater block 40. Therefore, the difference between the actual temperature of the sample gas in the sample loop and the set temperature of the heater block that heats the sample loop can be reduced. Therefore, the accuracy of the temperature of the sample gas in the sample loop can be enhanced, and as a result, the measurement accuracy of the sample gas in the sample loop can be improved.

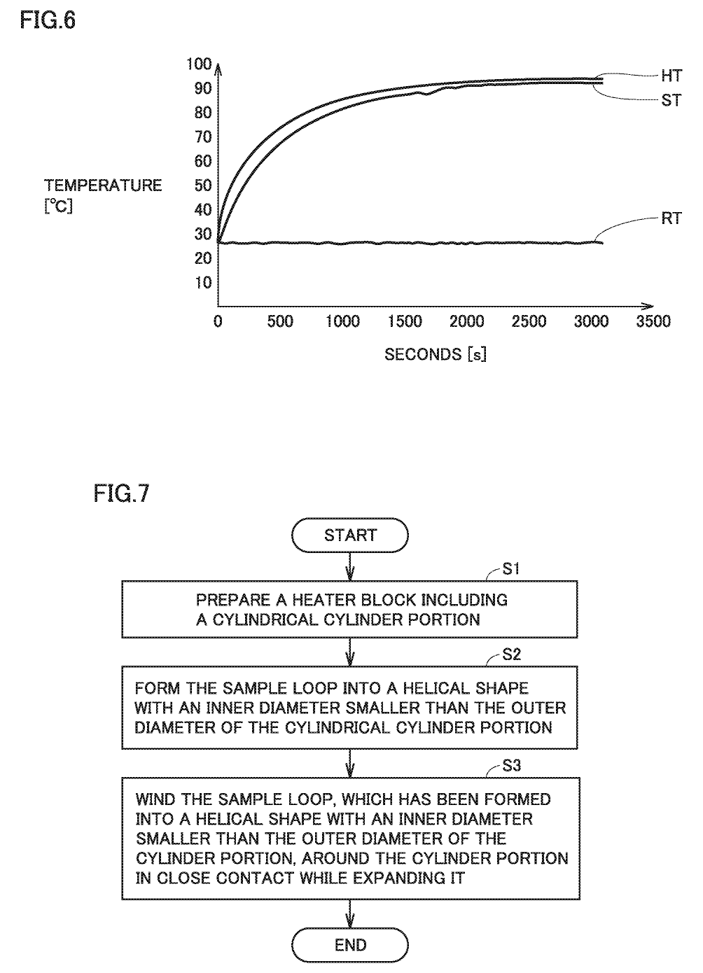

FIG. 6 is a graph showing temperature changes of the sample loop and the heater in the embodiment. The horizontal axis indicates the time since the start of heating of the heater block. The vertical axis shows the temperature HT of the heater inside the heater block, the temperature ST of the sample loop of the embodiment, and the room temperature RT of the room where the gas chromatograph apparatus is placed.

Referring to FIG. 6, when the room temperature RT is constant (25° C) regardless of time, there is almost no difference between the sample loop temperature ST and the heater temperature HT in a state where the temperature has stabilized after a certain period of time has elapsed since the start of heating. Therefore, in the configuration of the sample loop of the embodiment, the difference between the actual temperature of the sample gas in the sample loop and the set temperature of the heater block that heats the sample loop can be reduced. Therefore, the measurement accuracy of the sample gas in the sample loop can be improved.

### Method for Manufacturing Sample Loop Unit

FIG. 7 is a flowchart showing a manufacturing procedure for the sample loop unit 50 of the gas chromatograph apparatus 100 of the embodiment. First, a user prepares a heater block 40 including a cylindrical cylinder portion 42 (step S1). Next, the user forms the sample loop 30 into a helical shape with an inner diameter smaller than the outer diameter of the cylindrical cylinder portion 42 (step S2). The sample loop 30 is formed into a helical shape while maintaining a constant diameter. Finally, the user winds the sample loop 30, which has been formed into a helical shape with an inner diameter smaller than the outer diameter of the cylinder portion 42, around the cylinder portion 42 in close contact while expanding it in an elastic deformation region (step S3).

When a sample loop that was originally straight is formed into a helical shape, a force acts on the sample loop to return to its original straight shape to some extent due to elastic force. Therefore, the inner diameter of the helical sample loop tends to be slightly larger than the inner diameter at the time of forming. Therefore, the sample loop 30 is formed into a helical shape with an inner diameter smaller than the outer diameter of the cylindrical cylinder portion 42, and is wound around the cylinder portion 42 in close contact while slightly expanding the inner diameter of the sample loop 30 in the elastic deformation region.

By assembling the sample loop unit using such a method, a force acts on the sample loop 30 after attachment in a direction that reduces the inner diameter. Therefore, the sample loop 30 can be brought into close contact with the cylinder portion 42 without using a special member for pressing the sample loop 30 against the cylinder portion 42. As the contact area between the sample loop 30 and the cylinder portion 42 increases, the temperature of the sample loop 30 more easily approaches the temperature of the cylinder portion 42. Therefore, the difference between the actual temperature of the sample gas in the sample loop and the set temperature of the heater block that heats the sample loop can be reduced, and the measurement accuracy of the sample gas in the sample loop can be improved.

### Aspects

It will be understood by those skilled in the art that the plurality of exemplary embodiments described above are specific examples of the following aspects.

### Aspect 1

A gas chromatograph apparatus according to one aspect analyzes components contained in a gas to be analyzed. The gas chromatograph apparatus includes a measuring tube and a heater block. The measuring tube measures the gas. The heater block heats the measuring tube to a predetermined temperature. The measuring tube is in contact with the heater block and is wound around the heater block.

According to the gas chromatograph apparatus of Aspect 1, the sample loop can be heated by being brought into contact with the heater block. Therefore, the difference between the actual temperature of the sample gas in the sample loop and the set temperature of the heater block that heats the sample loop can be suppressed, and the measurement accuracy of the sample gas in the sample loop can be improved.

### Aspect 2

In the gas chromatograph apparatus according to Aspect 1, at least a part of the measuring tube is in direct contact with the heater block.

According to the gas chromatograph apparatus of Aspect 2, the sample loop can be heated by being brought into direct contact with the heater block. Therefore, the difference between the actual temperature of the sample gas in the sample loop and the set temperature of the heater block that heats the sample loop can be suppressed, and the measurement accuracy of the sample gas in the sample loop can be improved.

### Aspect 3

The gas chromatograph apparatus according to Aspect 1 further includes a thermally conductive member disposed between the heater block and the measuring tube so as to be in contact with the heater block and the measuring tube. At least a part of the measuring tube is in indirect contact with the heater block.

According to the gas chromatograph apparatus of Aspect 3, by disposing the thermally conductive member, heat from the heater block can be efficiently transferred to the sample loop via the thermally conductive member. Therefore, the time required to reach a desired temperature can be shortened, and the power consumption of the heater can be suppressed.

### Aspect 4

The gas chromatograph apparatus according to any one of Aspects 1 to 3 further includes a column and a flow path switching device. The column separates the gas for each component. The flow path switching device is connected to the measuring tube and the column, and switches between supplying and stopping the supply of the gas measured in the measuring tube to the column.

According to the gas chromatograph apparatus of Aspect 4, after removing impurities in the piping and filling the sample loop with a desired quantity of sample gas, component analysis of the sample gas can be performed.

### Aspect 5

In the gas chromatograph apparatus according to Aspect 4, the flow path switching device is disposed in contact with the heater block.

According to the gas chromatograph apparatus of Aspect 5, the flow path switching device, like the sample loop, can also be heated in a position proximate to the heater block. Therefore, the difference between the actual temperature of the sample gas in the valve and the set temperature of the heater block that heats the sample loop can be suppressed, and the measurement accuracy of the sample gas in the sample loop can be improved.

### Aspect 6

In the gas chromatograph apparatus according to any one of Aspects 1 to 5, the heater block includes a cylindrical cylinder portion. The measuring tube is wound in a helical shape around the cylinder portion.

According to the gas chromatograph apparatus of Aspect 6, the sample loop can be heated in contact with the heater block. Therefore, the difference between the actual temperature of the sample gas in the sample loop and the set temperature of the heater block that heats the sample loop can be suppressed, and the measurement accuracy of the sample gas in the sample loop can be improved.

### Aspect 7

A measuring tube unit according to one aspect is used in a gas chromatograph apparatus that analyzes components contained in a gas to be analyzed. The measuring tube unit includes a measuring tube and a heater block. The measuring tube measures the gas. The heater block heats the measuring tube to a predetermined temperature. The measuring tube is in contact with the heater block and is wound around the heater block.

According to the measuring tube unit of Aspect 7, the sample loop can be heated by being brought into contact with the heater block. Therefore, the difference between the actual temperature of the sample gas in the sample loop and the set temperature of the heater block that heats the sample loop can be suppressed, and the measurement accuracy of the sample gas in the sample loop can be improved.

### Aspect 8

A method for manufacturing a measuring tube unit according to one aspect relates to a method for manufacturing a measuring tube unit used in a gas chromatograph apparatus that analyzes components contained in a gas to be analyzed. The measuring tube unit includes a measuring tube and a heater block. The measuring tube measures the gas. The heater block heats the measuring tube to a predetermined temperature. The heater block includes a cylindrical cylinder portion. The manufacturing method includes a step of preparing the heater block, a step of forming the measuring tube into a helical shape with an inner diameter smaller than an outer diameter of the cylinder portion, and a step of winding the formed measuring tube around the cylinder portion in close contact while expanding it.

According to the method for manufacturing a measuring tube unit of Aspect 8, the sample loop 30 can be brought into close contact with the cylinder portion 42 without using a special member for pressing the sample loop 30 against the cylinder portion 42, and the contact area between the sample loop 30 and the cylinder portion 42 can be increased. Therefore, the difference between the actual temperature of the sample gas in the sample loop and the set temperature of the heater block that heats the sample loop can be reduced, and the measurement accuracy of the sample gas in the sample loop can be improved.

The embodiments disclosed herein should be considered in all respects as illustrative and not restrictive. The scope of the present invention is indicated by the claims rather than by the foregoing description of the embodiments, and all changes which come within the meaning and range of equivalency of the claims are intended to be embraced therein.

### REFERENCE SIGNS LIST

10 autosampler, 20 flow path switching device, 30 sample loop, 40 heater block, 42 cylinder portion, 44 flange portion, 50, 50A sample loop unit, 52 support member, 54 fixing member, 56 thermally conductive member, 60 carrier gas cylinder, 70 column, 80 column oven, 90 detector, 100 gas chromatograph apparatus, 110 control device, 112 storage device, 114 processor, 116 communication interface, 120 input device, 130 display device, P1, P2, P3, P4, P5, P6 port.

1. A gas chromatograph apparatus for analyzing components contained in a gas to be analyzed, the gas chromatograph apparatus comprising:
a measuring tube that measures the gas; and
a heater block that heats the measuring tube to a predetermined temperature,
wherein the measuring tube is in contact with the heater block and is wound around the heater block.

2. The gas chromatograph apparatus according to claim 1, wherein at least a part of the measuring tube is in direct contact with the heater block.

3. The gas chromatograph apparatus according to claim 1, further comprising a thermally conductive member disposed between the heater block and the measuring tube so as to be in contact with the heater block and the measuring tube,
wherein at least a part of the measuring tube is in indirect contact with the heater block.

4. The gas chromatograph apparatus according to claim 1, further comprising:
a column that separates the gas for each component; and
a flow path switching device connected to the measuring tube and the column, the flow path switching device switching between supplying and stopping a supply of the gas measured in the measuring tube to the column.

5. The gas chromatograph apparatus according to claim 4, wherein the flow path switching device is disposed in contact with the heater block.

6. The gas chromatograph apparatus according to claim 5, wherein the heater block includes a cylindrical cylinder portion, and
the measuring tube is wound in a helical shape around the cylinder portion.

7. A measuring tube unit for use in a gas chromatograph apparatus that analyzes components contained in a gas to be analyzed,
the measuring tube unit comprising:
a measuring tube that measures the gas; and
a heater block that heats the measuring tube to a predetermined temperature,
wherein the measuring tube is in contact with the heater block and is wound around the heater block.

8. A method for manufacturing a measuring tube unit for use in a gas chromatograph apparatus that analyzes components contained in a gas to be analyzed,
the measuring tube unit including:
a measuring tube that measures the gas; and
a heater block that heats the measuring tube to a predetermined temperature,
the heater block including a cylindrical cylinder portion,
the manufacturing method comprising:
a step of preparing the heater block;
a step of forming the measuring tube into a helical shape with an inner diameter smaller than an outer diameter of the cylinder portion; and
a step of winding the formed measuring tube around the cylinder portion in close contact while expanding the formed measuring tube.
